(19) United States
(12) Patent Application Publication
(10) Pub. No.: US 2026/0318295 A1
(43) Pub. Date: Oct. 15, 2026

(54) Proximity Sensor Having an Armored Sight Glass

(71) Applicant: Curtis Alan Roys, Fredericksburg, TX (US)

(72) Inventors: Curtis Alan Roys, Fredericksburg, TX (US); Duane Thomas Smith, Round Rock, TX (US); Rodney Herman, Austin, TX (US)

(21) Appl. No.: 19/643,160

(22) Filed: Apr. 9, 2026

Related U.S. Application Data
(62) Division of application No. 29/998,069, filed on Apr. 10, 2025.
(60) Provisional application No. 63/786,924, filed on Apr. 10, 2025.

(51) Int. Cl. F04B 51/00; G01D 7/00

(52) U.S. Cl. CPC F04B 51/00; G01D 7/00

(57) ABSTRACT

A cycle indicator includes a transparent protector, preferably glass, to protect an indicator moved by a magnet in a piston follower. The transparent glass protector is protected by a hard protective shield, preferably metal, having gaps through which the indicator can be observed. Markers are provided for quantifying the length of travel of the indicator, which corresponds to the length of travel of a piston in a divider block.

### TECHNICAL FIELD OF THE INVENTION

The present invention relates to lubrication systems for natural gas compressors, and in particular, to a device to observe the functioning of a divider block of a lubrication system.

### BACKGROUND OF THE INVENTION

Divider blocks are used to distribute a fluid at high pressure and low volume. Divider blocks are described, for example, in U.S. Pat. No. 7,096,889, to Roys, the applicant of the present application, for a “Fluid Divider Block Suitable for Use at High Pressures.” In a divider block, multiple pistons move back and forth to force lubricant towards divider block outlets connected by lubrication lines to lubrication points on a natural gas compressor. The pistons are moved by the pressure of the incoming lubricant. The moving pistons open and close passages in a fluid circuit that is designed to move the pistons back and forth and force lubricant through the outlets.

At times, the motion of the piston can vary from the prescribed movement. The pistons can suffer from reduced motion, i.e., “short stroking,” or can seize up and stop moving altogether. The pistons can also “slap,” that is, move so quickly that they slam into the end of the cylinder. Several devices have been used to observe the motion of the cylinders within a divider block. Some devices use a piston follower that trips an electric switch to count cycles. Such devices are typically binary, that is, either are tripped by the piston or not tripped, so the user cannot tell when the piston is not travelling the full prescribed length.

Because the amount of fluid that a divider block dispenses during each cycle is determined by the piston size and stroke, the amount of fluid dispensed by a divider block in a period of time can be determined using a cycle indicator that electronically counts the number of cycles the divider valve completes within the time period. U.S. Pat. No. 5,835,372 to Roys, et al., for an “Integrated Fluid Flow Evaluation Apparatus and Method” describes a device for counting cycles of divider blocks to determine fluid flow. Such cycle indicators typically have a piston follower that extends into a cylinder of the divider block through a seal and is pushed against the piston by a spring in the indicator. As the piston moves back and forth, the piston follower moves a magnet that activates a reed switch or a Hall effect sensor to indicate a cycle of the divider block.

A disadvantage of most prior art cycle indicators is that they only indicate that a cycle has occurred, but not how far the piston has moved. It is important for the operator to be able to determine movement of the piston because such movement indicates whether or not the correct quantity of oil is moved out of the piston cylinder bore. For example, a short piston cycle indicates that not enough oil is being supplied to the lubricated point, which may cause premature wear or failure of the component.

Some prior art cycle indicators, such as the Neomag Visual Cycle indicator from CPI, Chart Industries, Baton Rouge, Louisiana use a polycarbonate cover over a visual indicator. Some cleaning fluid and other contamination can cause the polycarbonate to cloud up, obscuring the indicator.

Some prior art systems use a glass enclosure for the indicator. When the indicator jams, for example, due to piston slap, users will often bang the indicator on a hard surface in an attempt to free the internal mechanism. Such banging can break the glass.

Sloan Lubrication Systems makes a cycle indicator described at https://sloanlubrication.com/products/sloan-accessories/divider-block-accessories/

Another prior art visual cycle indicator uses balls in races in a transparent housing surrounding the piston follower. A magnet causes the balls to track the movement of an internal magnet. The balls, however, tend to get stuck in their races.

US Pat. No. 7,461,670 to Roys, the applicant of the present invention, describes a cycle indicator for monitoring movement of a fluid control piston of a divider block for a fluid distribution system.

### SUMMARY OF THE INVENTION

An object of the invention is to provide a reliable visual indication of divider block piston travel.

A cycle indicator has a visual indicator in a transparent enclosure protected by a hard protective shield having openings through which the motion of the visual indicator can be observed. The hard protective shield around the transparent enclosure prevents breakage of the transparent enclosure. Markers on the hard protective shield allow a user to measure the distance that the piston moves.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 shows a cycle indicator attached to a divider block;

FIG. 2 shows front view of a cycle indicator according to this disclosure;

FIG. 3 shows an isometric view of the cycle indicator of FIG. 2;

FIG. 4 shows a sectional view of the cycle indicator of FIG. 2 taken along the lines 4---4;

FIG. 5 is an exploded view of the components that are positioned outside of the housing of the cycle indicator of FIG. 2;

FIG. 6 is an exploded view of the components that are located within the housing of the cycle indicator of FIG. 2; and

FIG. 7 is a flow chart showing steps of a method of operating lubricated equipment.

### DETAILED DESCRIPTION OF PREFERRED EMBODIMENTS

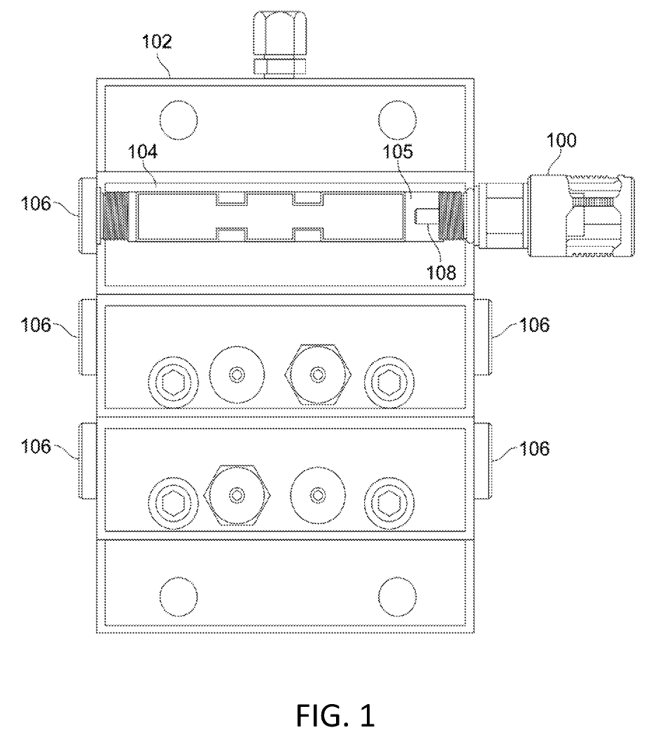

FIG. 1 shows a cycle indicator 100 in accordance with present disclosure attached to a divider block 102 that provides a lubricant at a high pressure and low volume to lubricated equipment (not shown), such as a natural gas compressor. Divider block 102 includes three pistons 104 (only one visible) within 3 cylinders 105 (only one visible). A portion of divider block 102 is shown removed to expose one piston 104 and cylinder 105. As pistons 104 are caused to move back and forth by lubricant pressure in a hydraulic circuit within divider block 102, the pressure of the incoming lubricant forces lubricant through outlets. While the divider block 102 is shown with end plugs 106 at five of the outlets, the plugs can be removed and tubing attached to deliver lubricant to the lubricated equipment. Piston follower 108 extends from cycle indicator 100 into cylinder 105. Although the piston follower 108 is not shown touching the piston in FIG. 1, the piston follower can be “pre-loaded” so that it always contacts the piston. Divider block 102 can have any number of cylinders 105 and associated and pistons 104.

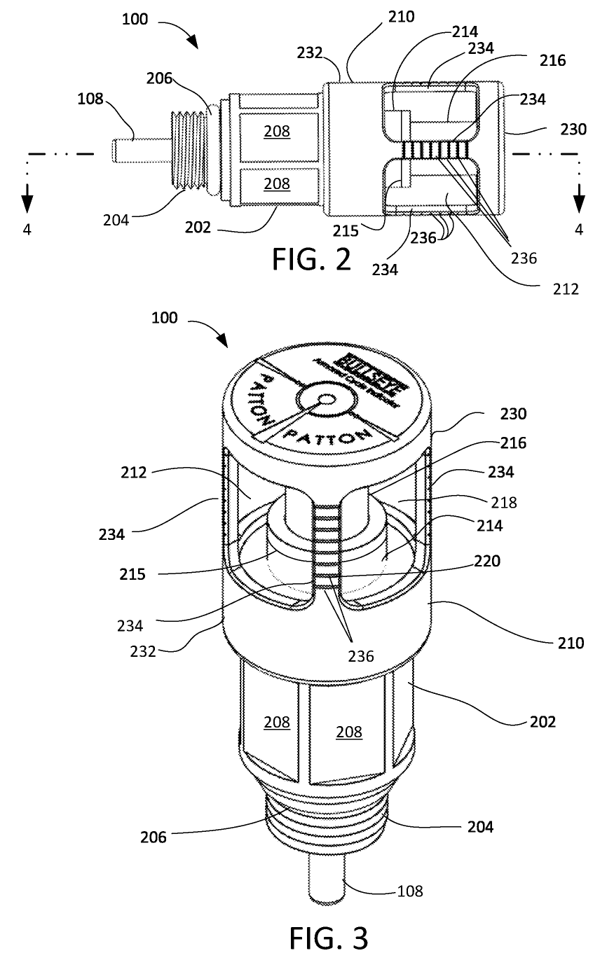

FIGS. 2 and 3 show respectively a front view and an isometric view of a cycle indicator 100. Cycle indicator 100 includes a body 202 including a threaded end 204 that screws into an outlet of divider block 102. An O-ring 206 seals the connection between the cycle indicator 100 and the divider block 102. Body 202 includes flats 208 for applying a wrench to screw cycle indicator 100 into divider block 102. A hard protective shield 210, preferably made of an essentially unbreakable material such as a metal, includes an upper portion 230 having a flat top and an annular lower portion 232. Extending between the upper portion 230 and annular lower portion 232 are bars 234 that preferably include markers 236. The hard protective shield 210 protects a transparent shield 212 that protects an annular visual indicator 214 that follows the motion of the divider block piston 108 as described in more detail below. Transparent shield 212 is preferably made of borosilicate glass or other sturdy glass or material that will not discolor over time and exposure to chemicals and to the sun. Annular indicator 214 moves on a cylindrical extension 216 of housing 202.

Markers 236, also called “tick marks” are machined into bars 234, for example, at a spacing of 0.050 between the markers. The spacing between the marks can vary with the specific implementation. The spacing should be small enough to provide an accurate indication of the piston travel to the operator yet sufficiently great to be readily distinguishable. The operator can compare the position of the end of the annular indicator 214 with the markers 236 to determine the extent of piston travel. In some embodiments, the annular indicator 214 can have one or more lines 215 inscribed, and the position of one of the lines 215 relative to the markers 236 can be used as the indication of piston travel. To enhance visibility, annular indicator 214 is preferably brightly colored, for example, bright red, to contrast with the rest of the device. Lines 215 are of a color, such as black, to contrast with the rest of annular indicator 214.

Markers 236 on the hard protective shield 210 allow a user to determine the extent of motion of the annular indicator 214 so that the user can determine whether the length of the piston travel meets the design specification or whether the piston is “short stroking,” which would indicate that it is delivering less lubricant that it should.

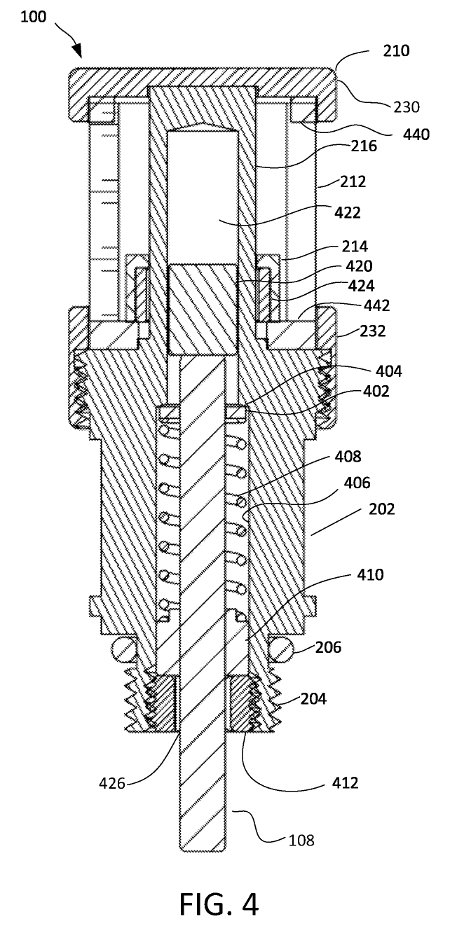

FIG. 4 shows a cross-sectional view taken along the plane 4—4 of FIG. 2. A washer 402 positioned against a shoulder 404 in a bore 406 of housing 202 provides a fixed surface within housing 202 for one end of a spring 408 to press against. Annular stop 410 encircles and is fixed relative to piston follower 108 and provides a surface for a second end of spring 408 to push against. Annular stop 410 may be press fit onto piston follower 108 or fixed by other means. A threaded plug 412 screwed into housing 202 prevents annular stop 410 and attached piston follower 108 from dropping out of housing 202.

A magnet 420 attached to the end of piston follower 108 by magnetism or other means moves within a bore 422 in housing 202 as the piston follower moves as pushed by the piston 104 or is returned by the biasing force of spring 408. Outside of the housing 202, an annular-shaped ferromagnetic follower ring 424 encircles housing extension 216 and magnetic force causes ferromagnetic follower ring 424 to follow the motion of magnet 420. Annular indicator 214 is attached to ferromagnetic follower ring 424 and so moves with ferromagnetic follower ring 424 and with magnet 420.

Ferromagnetic follower ring 424 does not need to be a magnet itself and may be, for example, a ferromagnetic stainless steel that can magnetically couple to magnet 420. Magnet 420 and ferromagnetic follower ring 424 comprise first magnetic component and second magnetic components that are magnetically coupled. A magnetic component as used herein does not need to be a magnet, but can be material that magnetically couples with a magnet. Annular indicator 214, preferably of a bright, easily seen color, is fixed to ferromagnetic follower ring 424 and allows a user to easily see the motion of annular indicator 214, and by association, the motion of the piston follower 108 and the piston 104. The ferromagnetic follower ring 424 and annular indicator 214 are surrounded by transparent protective cylinder 212. Transparent protective cylinder 212 is in turn protected by a hard protective shield 210, which screws into housing 202, and which includes gaps through which annular indicator 214 is visible. In some embodiments, ferromagnetic follower ring 424 and annular indicator 214 can be replaced by a single part that follows magnet 420 and is visible to a user.

Space 218 inside transparent protective cylinder 212 is sealed by a gasket 440 at the top and a gasket 442 at the bottom to eliminate environmental contamination that could interfere with the sliding of the ferromagnetic follower ring 424 and annular indicator 214. Space 218 is also sealed from lubricant that can permeate into cavity 422 and bore 406 within housing 202.

Spring 408 trapped between a washer 404 and annular stop 410 and biases piston follower 108 against piston 104 and moves piston follower 108 into cylinder 105 as the piston 104 moves away from the outlet at which cycle indicator 100 is attached. As piston 104 moves back to the left in FIG. 1, spring 408 presses on annular stop 410 to move piston follower 108 to the left, following piston 104.

The threads 204 of housing 202 and O-ring 206 form a liquid tight seal with divider block 102. Lubricant can flow into the interior of housing 202 through annular gap 426 immersing the components within cavity 406 and bore 422 in lubricant. Ferromagnetic follower ring 424, indicator 214, transparent protective cylinder 212, and hard protective shield 210 are outside of housing 202 and therefore do not come into contact with the lubricant.

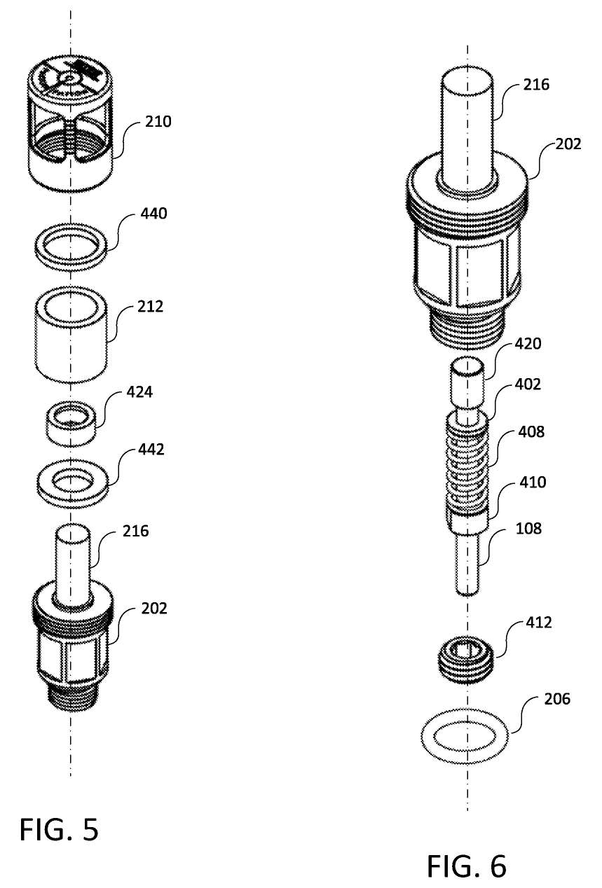

FIG. 5 shows an exploded view of the components that are positioned outside of the housing and FIG. 6 shows an exploded view of the components that are positioned inside of the housing. The components shown in FIGS. 5 and 6 are shown in the earlier figures and described above.

Unlike prior art plastic covers, a borosilicate glass cover will not degrade over time and lose its transparency. The metal cap protects the glass cover if an operator strikes the cycle indicator to unstick the indicator if it gets stuck. This may happen, for example, if unbalanced pressure slams the piston 104 towards the outlet to which the cycle indicator 100 is attached. The disclosed embodiment uses only a single magnet, and the follower comprises a ferromagnetic material that is attracted to the magnet and tracks its movement. Alternatively, the ferromagnetic material could take the place of the magnet inside the housing 202 and the annular follower could be magnet. Other configurations of magnets and followers could also be used.

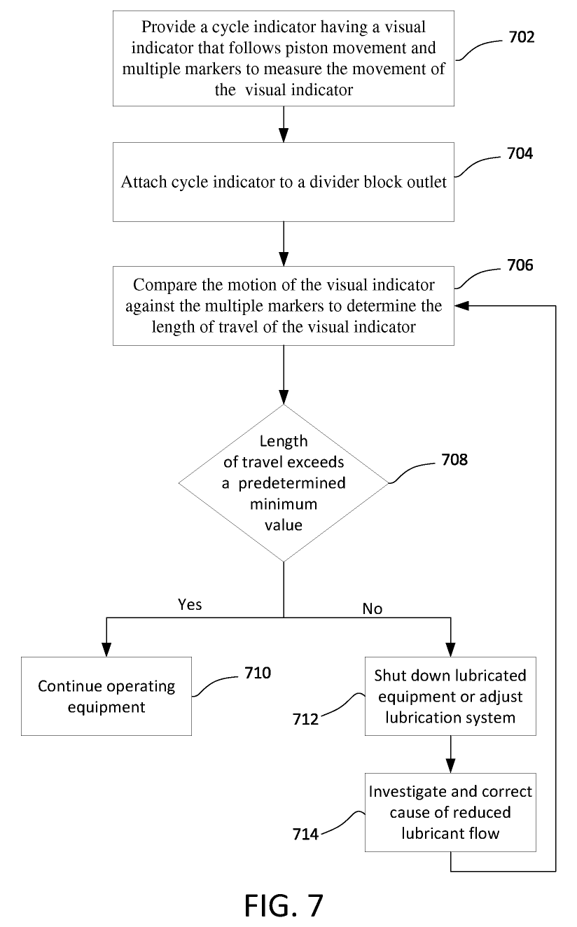

FIG. 7 shows a method of operating lubricated equipment. In step 702, a cycle indicator having a visual indicator that follows piston movement and multiple markers to measure the movement of the visual indicator is provided. In step 704, the cycle indicator is attached to the outlet of a divider block for providing lubrication to the lubricated equipment. In step 706 the position of the visual indicator at the extreme of its motion is compared against the multiple markers to determine the length of travel of the visual indicator. In decision block 708, if the length of travel exceeds a predetermined minimum value, the operator will know that the divider block is delivering the correct amount of fluid and the lubricated system continues in operation in block 710. If the length of travel does not exceed the predetermined minimum value in decision step 708, the operator shuts down the lubricated equipment in step 712 or adjusts the lubrication system if possible. In step 714, the operator investigates and corrects the cause of the reduced lubricant flow. Once the cause of the reduced flow is determined, the operator continues to operate and monitor the system in step 706.

Although the present invention and its advantages have been described in detail, it should be understood that various changes, substitutions and alterations can be made herein without departing from the spirit and scope of the invention as defined by the appended claims. For example, the visual indicator does not need to be annular. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A cycle indicator for indicating operation of a divider block, comprising:
a housing including a threaded end for connecting to an outlet of the divider block;
a piston follower extending from the housing interior through the threaded end and into a cylinder of a divider block;
a first magnetic component positioned within the housing and connected to the piston follower;
a visual indicator outside the housing;
a second magnetic component, outside of the housing magnetically coupled to the first magnetic component and connected to the visual indicator so that the position of the visual indicator correlates to the position of the piston;
a transparent protector protecting the second magnetic component and the visual indicator;
a hard protective shield protecting the transparent protector, the hard protective shield having gaps through which the visual indicator can be seen; and
multiple markers configured to allow a user to determine the length of travel of the visual indicator.

2. The cycle indicator of claim 1 in which the transparent protector comprises glass.

3. The cycle indicator of claim 2 in which the transparent protector comprises borosilicate glass.

4. The cycle indicator of claim 1 in which the first magnetic component comprises a permanent magnet and the second magnetic component comprises a ferromagnetic component.

5. The cycle indicator of claim 4 in which the second magnetic component comprises an annular ferromagnet component.

6. The cycle indicator of claim 1 in which the first magnetic component comprises a ferromagnetic component and the second magnetic component comprises a permanent magnet.

7. The cycle indicator of claim 1 in which the second magnetic component and the visual indicator are a single physical element.

8. The cycle indicator of claim 1 in which the multiple markers are positioned on the hard protective shield.

9. The cycle indicator of claim 1 in which the multiple markers are positioned on the transparent protector.

10. The cycle indicator of claim 1 in which the housing includes a cylindrical upper portion having a bore through which the first magnetic component moves and in which the second magnetic component encircles the cylindrical upper portion.

11. The cycle indicator of claim 1 in which the hard protective shield includes an upper portion and a lower portion, the upper and lower portions being connected by bars through which the visual indicator can be observed.

12. The cycle indicator of claim 11 in which the multiple markers are marked on the bars.

13. The cycle indicator of claim 1 in which the visual indicator includes a reference line for comparing the position of the visual indicator with the multiple markers.

14. The cycle indicator of claim 1 in which visual indicator is brightly colored.

15. The cycle indicator of claim 1 in which the hard protective shield comprises metal.

16. The cycle indicator of claim 1 in which the second magnetic component and the visual indicator are not in contact with lubricant.

17. The cycle indicator of claim 16 in which the second magnetic component and the visual indicator are protected from environmental contamination by the transparent protector.

18. A method of maintaining a lubricated system, comprising:
providing a cycle indicator in accordance with claim 1;
attaching the cycle indicator to a divider block that provides lubricant to the lubricated system;
comparing the motion of the visual indicator to the multiple markers to determine a length of travel of the piston; and
in response to the length of travel being less than a predetermined value, shutting down the lubricated system.

19. The method of claim 18 in which the visual indicator includes a reference line and in which comparing the motion of the visual indicator to the multiple markers to determine the length of travel of the piston includes comparing the position of the reference line to the multiple markers.
